(19) United States
(12) Patent Application Publication
(10) Pub. No.: US 2003/0074255 A1
(43) Pub. Date: Apr. 17, 2003

(54) Method of transmitting and receiving information using electronic mail

(76) Inventor: Seigou Tanigawa, Tokyo (JP)

Correspondence Address: Kanesaka & Takeuchi, 1423 Powhatan Street, Alexandria, VA, 22314, US

(21) Appl. No.: 09/958,952

(22) PCT Filed: Feb. 8, 2001
(86) PCT No.: PCT/JP01/00876

(30) Foreign Application Priority Data
Feb. 17, 2000 (JP) 2000-39202

(51) Int. Cl. G06F 17/60; G06F 15/16

(52) U.S. Cl. 705/14; 709/206

(57) ABSTRACT

The present invention comprises, for transmitting information such as an advertisement through an electronic mail while various points are added to user members in accordance with the contents of the actions of the members such as reception of an electronic mail from a mail delivery terminal or transmission of a reply to a received electronic mail, a member registered information database 4 for storing member registered information of the user members, transmission information input means for inputting information to be transmitted to members through an electronic mail, a program for selecting and transmitting members of the user members to whom a mail is to be delivered with reference to said member registered information database 4, and the mail delivery terminal 6 for transmitting an electronic mail to the selected user members. A point is added to a user member in accordance with the contents of the action of the member such as reception of an electronic mail from the mail delivery terminal 6 or transmission of a reply to a received electronic mail, and point information for each member is stored in the member registered information database 4.

### TECHNICAL FIELD

The present invention relates to a system and a method of inserting effective information such as an advertisement into an electronic mail to pass profits on to members who are users when the electronic mail is transmitted and received in a computer network on which computers, portable information terminals and the like are connected.

### BACKGROUND ART

In recent years, exchange of information through electronic mails has been commonly performed with developments in computer networks and communication environments.

Portable information terminals, cellular phones, PHSs and the like are also in widespread use in addition to information devices such as personal computers.

Devices provided with a browser function appear in cellular phones and the like and it has become possible to browse Web pages on the Internet from a cellular phone terminal.

Besides electronic mails for transmitting text data formed on such terminals to a terminal of a receiving side through mail servers, electronic mails in the form of HTML (Hyper Text Markup Language) are used. Also utilized are a system in which mail software is started on a terminal of a viewer by clicking on an HTML (Hyper Text Markup Language) link placed on a Web page, a system in which a mail can be transmitted by filling in a form on a Web page and pressing a transmission button, and the like.

With the wide use of electronic mails in this manner and an increased number of mails transmitted and received on portable terminals, a new service appears, for example free mails for providing a mail address at no charge to send mails on the Web, in an attempt to increase the number of users and to achieve differentiation from other sites.

In addition, exploitation of a large amount of electronic mails transmitted and received every day as advertising media has been generally seen.

As seen in Japanese Patent Laid-open No. 10-320314, recently, a delivery system which automatically inserts information such as an advertisement into an electronic mail to be transmitted is becoming common in an information transmission system such as a mail magazine or a mailing list for sending information to a plurality of users through an electronic mail.

For allowing a larger number of people to view information such as an advertisement with efficiency, it is necessary to increase the number of delivered electronic mails serving as advertising media into which an advertisement or the like can be inserted.

For effectively delivering an advertisement or the like to users (targets) with specific ages, sexes, hobbies and tastes, an effective approach is to allow insertion of an advertisement for each group according to the attributes of the users.

Thus, a method devised for increasing the number of users is that, with a members-only free electronic mail service, a point is provided for a service user when the user receives an advertisement mail or the like, and the accumulated points are passed on to the user as money or a prize.

In this method, however, while a point is added at the time of the action of receiving an electronic mail (seeing an advertisement or the like) by a user or at the time of the action of transmitting an electronic mail, it is difficult to pass various points on to users in accordance with other various actions.

It also has been difficult conventionally for a user member to select a prize to his taste on line from incentives such as various prizes and to apply for the selected prize.

In addition, according to the prior art, there are limitations on totally automatic execution, on a network, of the realization of various methods for conducting a questionnaire, quiz or the like on the Web to pass incentives such as a prize on to uses according to the methods, and it is a reality that such realization is made in combination with manual counting or the like.

### DISCLOSURE OF THE INVENTION

It is thus an object of the present invention to provide a system which solves the aforementioned various problems, allows a transmitter to select and transmit targets from user members to whom the transmitter wishes to communicate information such as an advertisement, provides a user member with various bonuses according to the reactions of the member, and automatically realizes a series of those operations on line.

It is another object of the present invention to provide a system which allows a user member to select a bonus to be offered to the user from a plurality of incentives and automatically realizes a series of the operations on line.

It is a further object of the present invention to provide a system for developing various campaign methods or the like on line which conventionally have been difficult to realize, and for automatically realizing a series of the operations on line.

It is also an object of the present invention to provide a system which can collect information such as tastes of users through such a system to serve well in market research or the like.

The invention described in claim 1 is characterized, to solve the aforementioned problems, by providing an information transmission and reception system using an electronic mail comprising, on a network on which a computer or a portable information terminal is connected: a member registered information database for storing member registered information of user members; transmission information input means for inputting information to be transmitted to members through an electronic mail; a program for selecting and transmitting members of the user members to whom a mail is to be delivered with reference to said member registered information database; and a mail delivery terminal for transmitting an electronic mail to the selected user members, characterized in that a point is added to a user member in accordance with the contents of an action of the member such as reception of an electronic mail from the mail delivery terminal or transmission of a reply to a received electronic mail, and point information for each member is stored in the member registered information database.

The invention described in claim 2 is characterized, to solve the aforementioned problems, by providing an information transmission and reception system using an electronic mail comprising, on a network on which a computer or a portable information terminal is connected: a member registered information database for storing member registered information of user members; transmission information input means for inputting information to be transmitted to user members through an electronic mail; a program for selecting and transmitting destination user members of the user members to whom a mail is to be delivered with reference to said member registered information database; and a mail delivery terminal for transmitting an electronic mail to the selected user members, characterized in that a point is added to a user member in accordance with the contents of an action of the member such as reception of an electronic mail from a mail delivery server or transmission of a reply to a received electronic mail, and point information for each member is stored in the member registered information database, and that the information transmission and reception system further comprises a prize database for storing information on incentives such as a plurality of points, prizes or services, and that a user member selects any of the incentives from said prize database, and information selected by each user member is stored in the member registered database.

The invention described in claim 3 is characterized, to solve the aforementioned problems, by providing an electronic mail information transmission and reception system comprising, on a network on which a computer or a portable information terminal is connected: a member registered information database for storing member registered information of user members; transmission information input means for inputting information to be transmitted to user members through an electronic mail; a program for selecting and transmitting destination user members of the user members to whom a mail is to be delivered with reference to said member registered information database; and a mail delivery terminal for transmitting an electronic mail to the selected user members, characterized in that the electronic mail information transmission and reception system further comprises a present information database for storing information on prizes presented to a user member; and a lottery program for conducting a lottery, and that, when a user member transmits a reply to present information inserted into an electronic mail transmitted from a mail delivery server for application, said lottery program for selecting a winner from a plurality of user members who have transmitted reply mails for application determines one or a plurality of winners for each prize stored in said present reception database.

The invention described in claim 4 is characterized, to solve the aforementioned problems, by providing, in the invention in claim 3, the electronic mail information transmission and reception system characterized in that the present information database has information stored therein for limiting application conditions such as an application term, the number of applications, or an applicant qualification, and only applications satisfying the application conditions are received.

The invention described in claim 5 is characterized, to solve the aforementioned problems, by providing, in the invention in claim 1 or 2, a member electronic mail information transmission and reception system characterized in that the mail delivery server for transmitting an electronic mail to users acquires a transmission log or acquires a reception log of reply mails transmitted from users, and said acquired transmission or reception log is stored in said member registered information database, and that, when a point is added to a user member in accordance with the contents of an action of the member such as reception of an electronic mail from the mail delivery server or transmission of a reply to a received electronic mail, the point is added with an upper limit or a lower limit set to the number of electronic mail transmissions or receptions.

The invention described in claim 6 is characterized, to solve the aforementioned problems, by providing a winner determination system using an electronic mail comprising, on a network on which a computer or a portable information terminal is connected: a member registered information database for storing member registered information of user members; transmission information input means for inputting information to be transmitted to user members through an electronic mail; a program for selecting and transmitting destination user members of the user members to whom a mail is to be delivered with reference to said member registered information database; and a mail delivery terminal for transmitting an electronic mail to the selected user members, characterized in that the winner determination system further comprises a present information database for storing information on prizes presented to a user member; and a determination program for determining whether an answer in a reply mail from a user member to a quiz provided on an electronic mail, a WEB page or the like is correct or not, and that, when a user member transmits a reply to information such as a quiz or a questionnaire for answer, said determination program for determining a winner from a plurality of user members who have transmitted reply mails for application determines one or a plurality of winners for each prize stored in said present reception database.

The invention described in claim 7 is characterized, to solve the aforementioned problems, by providing, in the invention in claim 6, the winner determination system using an electronic mail characterized in that information such as a quiz or a questionnaire provided on an electronic mail, a WEB page or the like is provided over a plurality of questions, and that, when a user member transmits a reply to information such as a quiz or a questionnaire for answer, the process of determining one or a plurality of winners for each prize stored in said present information database by said determination program for determining a winner from a plurality of user members who have transmitted reply mails for application is repeated a plurality of times in accordance with the number of the questions such that winners of a second quiz or the like are selected from winners of a first quiz or the like until a final winner is determined.

The invention described in claim 8 is characterized, to solve the aforementioned problems, by providing, in the invention in any of claims 1 to 7, a market research system using an electronic mail characterized by further comprising a market research program for counting and analyzing actions for each user member or for each attribute information of user members, and in that an action of a user member such as transmission of a reply to an electronic mail, application for a present, a quiz, a questionnaire or the like, or selection of a prize from a plurality of prizes is stored in said member registered database, and said market research program refers to, counts, and analyzes these information.

### BRIEF DESCRIPTION OF THE DRAWING

FIG. 1 is a system configuration diagram illustrating a basic configuration of a system according to the present invention.

### DESCRIPTION OF THE REFERENCE NUMBERS

1 user member terminal

2 user member terminal

3 SMTP server

4 member registered information database

6 mail delivery terminal

8 present reception database

### BEST MODE FOR CARRYING OUT THE INVENTION

An embodiment will hereinafter be described with reference to the drawing.

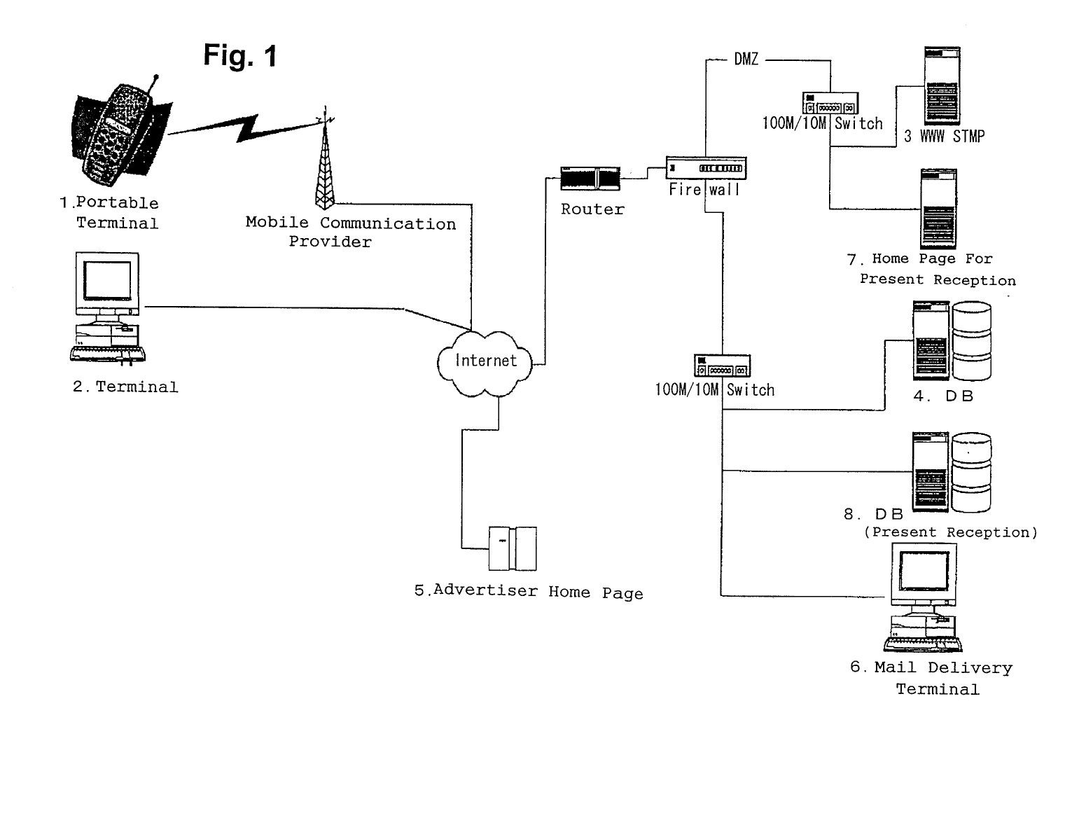

FIG. 1 is a system configuration diagram illustrating a basic configuration of a system according to the present invention.

Terminals of user members for connection to a network include a radio communication terminal 1 which is a cellular phone or a PHS, and various types of computer terminals 2 including a portable information terminal incorporating those functions. The terminal of a user member may be a so-called home information appliance such as an electronic device containing a computer as its contents.

The present invention is assumed to be realized as a members-only system in which users are registered as members, and comprises a member registered information database 4 for storing member registered information of the user members.

The member registered information database 4 has user attribute information stored therein such as names, sexes, ages, mail addresses, and residences of the registered user members. For the information, data is collected at the time of member registration. In addition, it is possible to store logs or the like for actions of the user members such as transmission and reception of mails after the registration, and application for a questionnaire, a quiz, a campaign or the like.

It should be noted that the member registration can be made on the Internet through a computer, a portable information terminal of a user, or the like. Besides, the registration can be made at a shop of a portable information terminal or the like, or the registration can be made off line by telephone, fax or other methods.

The system according to the present invention further comprises a program for selecting and transmitting members of the user members to whom an electronic mail is to be transmitted with reference to said member registered information database 4, and a mail delivery terminal 6 for transmitting an electronic mail to the selected user members.

An electronic mail to be transmitted to the user members is transmitted through a terminal on the side of an administrator in the system according to the present invention, i.e. the mail delivery terminal 6.

In the mail delivery terminal 6, an operator selects targets to whom information is to be delivered through an electronic mail, inputs the contents of the electronic mail to be transmitted, and transmits the electronic mail, with a mail delivery menu for an advertisement or the like, i.e. transmission information input means.

The mail delivery menu (transmission information input means) through which the operator performs those operations has been previously set as a form provided in a Web page on line or a form for allowing input off line.

In addition to the method of inputting the contents of the electronic mail to be transmitted through said transmission information input means, the contents may be stored in a transmission information database provided in advance for storing information to be transmitted to the members.

Such information is, for example, information of an advertisement or the like provided by an advertiser who wishes to deliver the advertisement or information by using the present system. Those advertisements may be not only a sentence in simple text form but also one with a hyperlink in the form of HTML for displaying information in a Web page of the advertiser in response to a click, or one responsive to a click to start software for transmitting an electronic mail to the advertiser. The delivered information may be information such as an image, moving image, and sound other than the text information.

The mail delivery menu (transmission information input means) has a function of recognizing a delivery conditions satisfying person for selecting targets to whom the electronic mail is to be transmitted. When the advertiser or the like inputs delivery conditions such as a desired delivery area, an address or a hobby of the targets, it is possible to recognize the number of the members satisfying the input delivery conditions with reference to said member registered information database 4. If the number of the delivery targets recognized at this time is too high or too low, the input conditions can be changed to adjust the number of the targets or the like.

The mail delivery menu also has a function of transmitting an electronic mail. The operator sets contents of information such as an advertisement to be transmitted through the electronic mail, a URL inserted into the electronic mail to which transfer is to be made (to which a hyperlink is to be connected), a point added to a member at the time of an action by the member such as reception of the electronic mail or reference to said URL to which transfer is made.

It should be noted that while the set information may be input through said mail delivery menu and stored in said transmission information database for storing the set information, it is possible to employ a method in which the information is input and stored in advance in the transmission information database for storing the information to make selections at the time of transmission or the like with reference to the database.

It is also possible to set various information other than the aforementioned information, such as a point added to a member when the advertisement produces an effect or leads to sale of a product.

The electronic mail input and set as described above is transmitted to the delivery targets through an SMTP server 3 when the operator provides a direction of transmission for the mail delivery terminal 6.

At this time, said SMTP server 3 checks the information contents of the electronic mail, and inserts hyperlink information into the electronic mail if a URL to which transfer is to be made is present, and the like.

At the transmission of the electronic mail, if setting is made such that a point is added to a member who receives the electronic mail, the point is added in the member registered information database 4.

If setting is made such that a point is added when a member refers to the URL to which transfer is to be made inserted into the electronic mail, the following steps are performed. Specifically, if the electronic mail received by a user member includes a URL description to which transfer is to be made, the member selects the link information and clicks or the like, thereby connecting to said SMTP server.

The SMTP server 3 acquires information such as a point when the member refers to the URL to which transfer is to be made with reference to said transmission information database for storing the electronic mail set information, and adds the point in the member registered database 4.

As described above in detail, according to the present invention described in claim 1, information such as an advertisement through an electronic mail can be transmitted while a point is added to a user member in accordance with the contents of an action of the member such as reception of an electronic mail from the mail delivery terminal or transmission of a reply to a received electronic mail.

According to the present invention described in claim 2, in addition to the present invention described in claim 1, a system further comprises a prize database for storing information on incentives such as a plurality of points, prizes or services.

A user member can refer to said prize database through the Internet or the like and can select any of the incentives from said plurality of points, prizes or the like. Information on the point, prize or the like selected by each user member is stored in the member registered database 4. In this manner, a user member can select any of the plurality of points, prizes or the like.

According to the present invention described in claim 3, in addition to the present invention described in claim 1, a system further comprises a present reception database 8 for storing information on prizes presented to a user member, and a lottery program for conducting a lottery.

When an advertiser or the like gives a present by lottery for a prize or the like, information on details of one or a plurality of prizes, the number of winners and the like is stored in the present reception database 8.

When a user member transmits a reply to present information inserted into an electronic mail transmitted from the mail delivery terminal 6 for application, or when a predetermined number of applications or applications over a predetermined time period are received, said lottery program for selecting a winner with random numbers or the like from user members who have transmitted reply mails for application determines one or a plurality of winners for each prize stored in said present reception database 8.

According to the present invention described in claim 4, in the present invention in claim 3, the present reception database 8 has information stored therein for limiting application conditions such as an application term, the number of applications, or an applicant qualification.

Thus, when a mail for application is sent from a user member, the SMTP server 3 checks the mail for application with reference to said present reception database 8 to allow reception only of the applications satisfying said application conditions.

According to the present invention described in claim 5, in the present invention in claim 1 or 2, the mail delivery terminal 6 for transmitting an electronic mail to users acquires a transmission log or acquires a reception log of reply mails transmitted from users.

Said acquired transmission or reception log is stored in said member registered information database 4, and when a point is added to a user member in accordance with the contents of an action of the member such as reception of an electronic mail from the mail delivery terminal or transmission of a reply to a received electronic mail, the point is added with an upper limit or a lower limit set to the number of electronic mail transmissions or receptions.

According to the present invention described in claim 6, a system comprises, on a network on which a computer or a portable information terminal is connected, a member registered information database 4 for storing member registered information of user members, transmission information input means for inputting information to be transmitted to user members through an electronic mail, a program for selecting and transmitting destination user members of the user members to whom a mail is to be delivered with reference to said member registered information database 4, a mail delivery terminal 6 for transmitting an electronic mail to the selected user members, a present reception database 8 for storing information on prizes presented to a user member, and a determination program for determining whether an answer in a reply mail from a user member to a quiz provided on an electronic mail, a WEB page or the like is correct or not.

When a user member transmits a reply to information such as a quiz or a questionnaire for answer, said determination program for determining a winner from a plurality of user members who have transmitted reply mails for application determines one or a plurality of winners for each prize stored in the present reception database 8.

According to the present invention described in claim 7, in the present invention in claim 6, information such as a quiz or a questionnaire provided on an electronic mail, a WEB page or the like is provided over a plurality of questions.

When a user member transmits a reply to information such as a quiz or a questionnaire for answer, the process of determining one or a plurality of winners for each prize stored in the present reception database 8 by said determination program for determining a winner from a plurality of user members who have transmitted reply mails for application is repeated a plurality of times in accordance with the number of the questions such that winners of a second quiz or the like are selected from winners of a first quiz or the like until a final winner is determined. Thus, various projects can be realized such as providing quizzes at several different times.

According to the present invention described in claim 8, in the present invention any one of claims 1 to 7, a system further comprises a market research program for counting and analyzing actions for each user member or for each attribute information of user members. An action of a user member such as transmission of a reply to an electronic mail, application for a present, a quiz, a questionnaire or the like, or selection of a prize from a plurality of prizes is stored in said member registered database 4, and said market research program refers to, counts, and analyzes these information. Therefore, it is possible to obtain marketing data desired by an advertiser or the like, or measurement data on effects of an advertisement or the like.

Induatrial Availability

Since the present invention is configured as described above, it is possible to provide a system which can transmit information such as an advertisement through an electronic mail while a point is added to a user member in accordance with the contents of an action of the member such as reception of an electronic mail from the mail delivery terminal or transmission of a reply to a received electronic mail. In addition, it is possible to provide a system which allows a user member to select a prize to his taste on line from incentives such as various prizes and to apply for the selected prize. Furthermore, it is possible to provide a system which can realize various methods for conducting a questionnaire, a quiz or the like on the Web, pass incentives such as a prize on to users in accordance with the methods, and realize market research, measurement of effects of an advertisement or the like. Thus, the present invention is significantly useful industrially.

What is claimed is:

1. An information transmission and reception system using an electronic mail comprising, on a network on which a computer or a portable information terminal is connected:
a member registered information database for storing member registered information of user members;
transmission information input means for inputting information to be transmitted to members through an electronic mail;
a program for selecting and transmitting members of the user members to whom a mail is to be delivered with reference to said member registered information database; and
a mail delivery terminal for transmitting an electronic mail to the selected user members,
characterized in that a point is added to a user member in accordance with the contents of an action of the member such as reception of an electronic mail from said mail delivery terminal or transmission of a reply to a received electronic mail, and point information for each member is stored in said member registered information database.

2. An information transmission and reception system using an electronic mail comprising, on a network on which a computer or a portable information terminal is connected:
a member registered information database for storing member registered information of user members;
transmission information input means for inputting information to be transmitted to user members through an electronic mail;
a program for selecting and transmitting destination user members of the user members to whom a mail is to be delivered with reference to said member registered information database; and
a mail delivery terminal for transmitting an electronic mail to the selected user members,
characterized in that a point is added to a user member in accordance with the contents of an action of the member such as reception of an electronic mail from said mail delivery terminal or transmission of a reply to a received electronic mail, and point information for each member is stored in said member registered information database,
and that the information transmission and reception system further comprises a prize database for storing information on incentives such as a plurality of points, prizes or services,
and that a user member selects any of the incentives from said prize database, and information selected by each user member is stored in the member registered database.

3. An electronic mail information transmission and reception system comprising, on a network on which a computer or a portable information terminal is connected:
a member registered information database for storing member registered information of user members;
transmission information input means for inputting information to be transmitted to user members through an electronic mail;
a program for selecting and transmitting destination user members of the user members to whom a mail is to be delivered with reference to said member registered information database; and
a mail delivery terminal for transmitting an electronic mail to the selected user members,
characterized in that the electronic mail information transmission and reception system further comprises a present reception database for storing information on prizes presented to a user member; and
a lottery program for conducting a lottery,
and that, when a user member transmits a reply to present information inserted into an electronic mail transmitted from the mail delivery terminal for application, said lottery program for selecting a winner from a plurality of user members who have transmitted reply mails for application determines one or a plurality of winners for each prize stored in said present reception database.

4. The electronic mail information transmission and reception system according to claim 3, characterized in that said present reception database has information stored therein for limiting application conditions such as an application term, the number of applications, or an applicant qualification, and only applications satisfying the application conditions are received.

5. A member electronic mail information transmission and reception system according to claim 1 or 2, characterized in that the mail delivery terminal for transmitting an electronic mail to users acquires a transmission log or acquires a reception log of reply mails transmitted from users, and said acquired transmission or reception log is stored in said member registered information database,
and that, when a point is added to a user member in accordance with the contents of an action of the member such as reception of an electronic mail from said mail delivery terminal or transmission of a reply to a received electronic mail, the point is added with an upper limit or a lower limit set to the number of electronic mail transmissions or receptions.

6. A winner determination system using an electronic mail comprising, on a network on which a computer or a portable information terminal is connected:
a member registered information database for storing member registered information of user members;
transmission information input means for inputting information to be transmitted to user members through an electronic mail;
a program for selecting and transmitting destination user members of the user members to whom a mail is to be delivered with reference to said member registered information database; and
a mail delivery terminal for transmitting an electronic mail to the selected user members,
characterized in that the winner determination system further comprises a present reception database for storing information on prizes presented to a user member; and
a determination program for determining whether an answer in a reply mail from a user member to a quiz provided on an electronic mail, a WEB page or the like is correct or not,
and that, when a user member transmits a reply to information such as a quiz or a questionnaire for answer, said determination program for determining a winner from a plurality of user members who have transmitted reply mails for application determines one or a plurality of winners for each prize stored in said present reception database.

7. The winner determination system using an electronic mail according to claim 6, characterized in that information such as a quiz or a questionnaire provided on an electronic mail, a WEB page or the like is provided over a plurality of questions,
and that, when a user member transmits a reply to information such as a quiz or a questionnaire for answer, the process of determining one or a plurality of winners for each prize stored in said present reception database by said determination program for determining a winner from a plurality of user members who have transmitted reply mails for application is repeated a plurality of times in accordance with the number of the questions such that winners of a second quiz or the like are selected from winners of a first quiz or the like until a final winner is determined.

8. A market research system using an electronic mail according to any one of claims 1 to 7, characterized by further comprising a market research program for counting and analyzing actions for each user member or for each attribute information of user members,
and in that an action of a user member such as transmission of a reply to an electronic mail, application for a present, a quiz, a questionnaire or the like, or selection of a prize from a plurality of prizes is stored in said member registered database, and said market research program refers to, counts, and analyzes these information.
